(19) United States
(12) Patent Application Publication
(10) Pub. No.: US 2022/0104443 A1
(43) Pub. Date: Apr. 7, 2022

(54) FRAME STRUCTURE OF AQUAPONIC SYSTEM ASSEMBLED BY MODULE ELEMENTS

(71) Applicant: Mytek International Inc., Bonita, CA (US)

(72) Inventor: Liang-Chi CHANG, New Taipei City (TW)

(21) Appl. No.: 17/060,736

(22) Filed: Oct. 1, 2020

(51) Int. Cl. A01G 31/06; F16B 12/10; A01K 63/04

(52) U.S. Cl. CPC A01G 31/06; A01G 2031/006; A01K 63/04; F16B 12/10

(57) ABSTRACT

A frame structure of aquaponic system assembled by module elements, comprising a base, at least a cultivating tank, a fix cover and a plurality of connecting members. Said elements of a frame structure are connected by the friction of elements through mortise-tenon joint and are easy for assembly and maintenance.

### BACKGROUND OF INVENTION

### 1. Field of the Invention

The present invention relates to an aquaponic system, and more particularly to a frame structure assembled by module elements in the way of tenon-mortise structure and bearing at least one layer of cultivating tank.

### 2. Description of Related Art

Referring to FIG. 1 and FIG. 2, the U.S. Pat. No. 9,775,330 disclosed an aquaponic system comprises an aquarium 10, a frame 20 and a plurality of cultivating tanks 30, wherein the frame 10 includes a plurality of connectors 21, a plurality of upright tubes 22, a plurality of transverse tubes 23, a plurality of pins 27 and a plurality of fasteners 28. Each of the connectors 21 is hollow and allows insertion of two of the upright tubes 22. Each of the connectors 21 is provided with two mounting sleeves 29 allowing insertion of two of the transverse tubes 23. The two mounting sleeves 29 are perpendicular to each other. Each of the connectors 21, each of the mounting sleeves 29, each of the upright tubes 22, each of the transverse tubes 23 and each of the adjusting tubes 24 is provided with an aperture 211, 291, 221, 231 and 242 allowing insertion of the pins 27 and fastened by the fasteners 28. Each of the pins 27 is provided with an annular groove 271. Each of the fasteners 28 is provided with a C-shaped snap ring 281 retained in the annular groove 271 of one of the pins 27.

The frame structure of said aquaponic system must be assembled of numerous elements and fittings by skilled person with tools. Obviously, average consumers are incompetent for it. Once part of the elements is destroyed, it is unlikely to be replaced by standard part. Therefore, how to modularize and standardize the elements of the frame structure of aquaponic system for easy assembly without specific tools is a worthy topic to research and to develop in the current E-commerce business model of on-line distribution and after-sales logistics.

### SUMMARY OF THE INVENTION

The main objective of the present invention is to modularize various elements of the frame structure of aquaponic system, so that the consumers can easy assemble without specific tools, the standardize elements are favorable for assembly and maintenance.

Therefore, the present invention provides a frame structure of aquaponic system assembled by module elements, comprising a base, at least a cultivating tank, a fix cover and a plurality of connecting members. Said elements of a frame structure are connected by the friction of elements through mortise-tenon joint.

According to said structural feature, the base is a rectangular base composed of a first [symbol] -shaped base, a second [symbol] -shaped base and a connecting member transversely connecting the first [symbol] -shaped base and the second [symbol] -shaped base.

According to said structural feature, the fix cover is a rectangular frame composed of a first [symbol] -shaped frame, a second [symbol] -shaped frame and a connecting member transversely connecting the first [symbol] -shaped frame and the second [symbol] -shaped frame.

According to said structural feature, the long side of the cultivating tank is provided with connecting lugs for the connecting member to pass through.

According to said structural feature, one end of the connecting member is formed into a tenon, the other end is formed into a mortise.

According to said structural feature, the cross section of the mortise and tenon is a three-circle intersection of Venn diagram.

### BRIEF DESCRIPTION OF THE DRAWINGS

FIG. 1 is the structural diagram of the U.S. Pat. No. 9,775,330.

FIG. 2 is the partial exploded view of the frame structure of the U.S. Pat. No. 9,775,330.

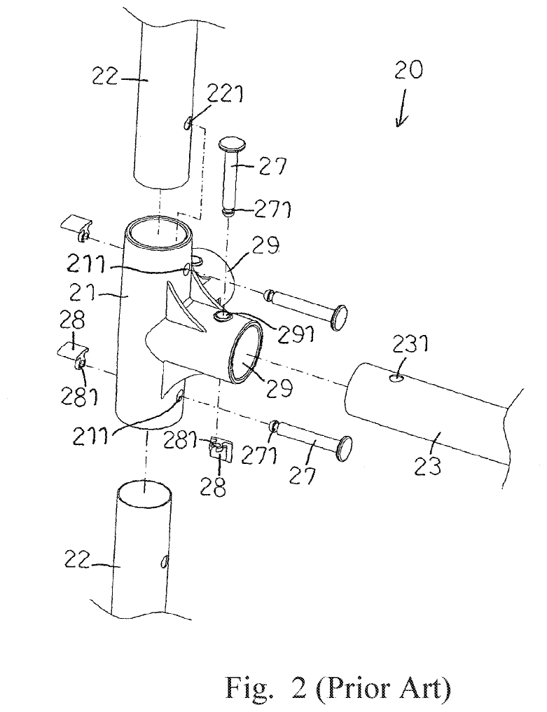

FIG. 3 is the exploded diagram of the structure of the present invention.

FIG. 4 is the combined diagram of the structure of the present invention.

### DETAILED DESCRIPTION OF THE INVENTION

To help those skilled in the art understand the objective of the present invention, a preferred embodiment of the present invention is described in detail with reference to the accompanying drawings:

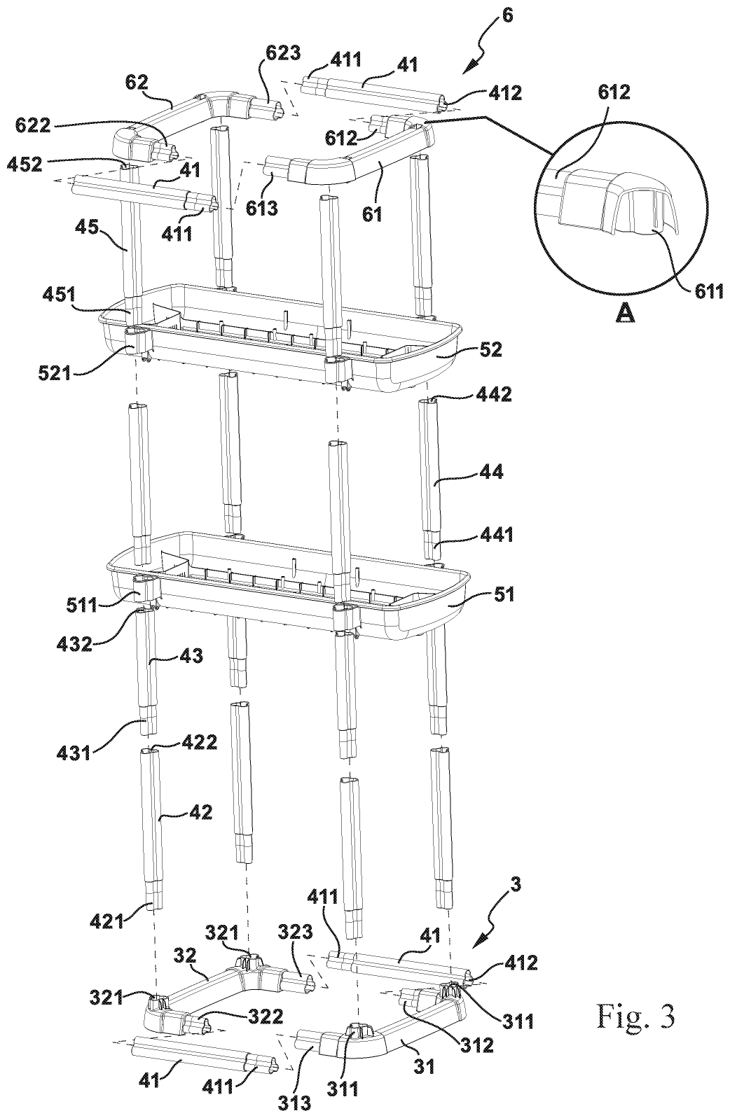

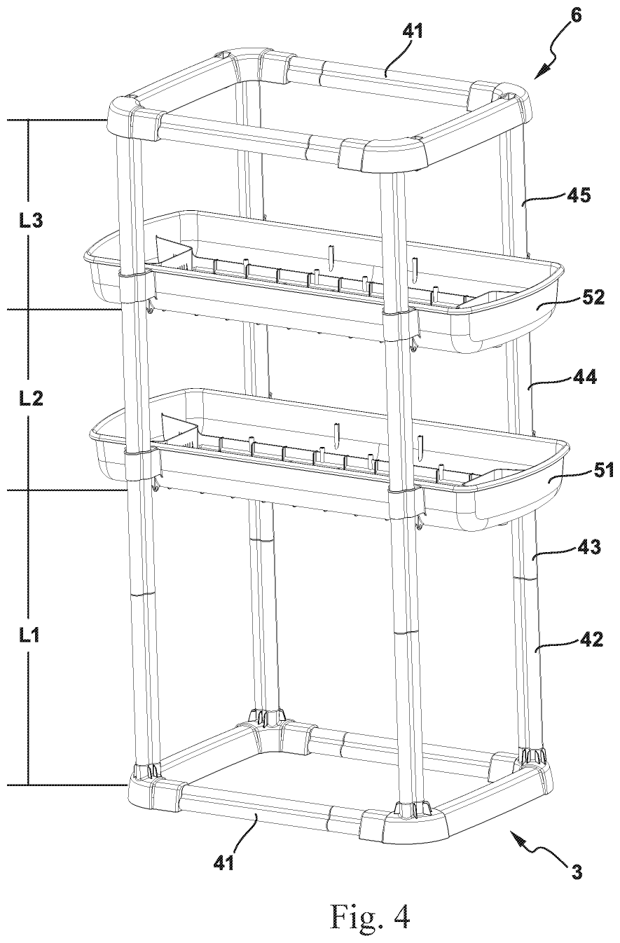

The exploded diagram of the present invention is shown in FIG. 3 and the combined diagram of the present invention is shown in FIG. 4, where a frame structure of aquaponic system assembled by module elements comprises a base, at least one cultivating tank, a fix cover and a plurality of connecting members. Said elements are connected by the friction of elements through mortise-tenon joint, wherein:

The base 3 is a rectangular frame, comprising a first [symbol] -shaped base 31, a second [symbol] -shaped base 32 and a first connecting member 41 transversely connecting the first [symbol] -shaped base 31 and the second [symbol] -shaped base 32. A mortise 311 is arranged upwards at two corners of the first [symbol] -shaped base 31 respectively, two horizontal ends are formed into mortise 312 or tenon 313 respectively, so as to correspond to the tenon 411 or mortise 412 at one end of first connecting member 41. In like manner, a mortise 321 is arranged upwards at two corners of the second [symbol] -shaped base 32 respectively, and two horizontal ends are formed into mortise 323 or tenon 322 respectively, so as to correspond to the tenon 411 or mortise 412 at the other end of first connecting member 41. The cross section of said mortise and tenon is not circle or square, but the three-circle intersection of Venn diagram, the frieze with clear dent at the intersection enhances the strength of elements, and avoids both of slide after inserting and influencing the stability.

Similar to said base 3, the fix cover 6 is also a rectangular frame, comprising a first [symbol] -shaped frame 61, a second [symbol] -shaped frame 62 and a first connecting member 41 transversely connecting the first [symbol] -shaped frame 61 and the second [symbol] -shaped frame 62. A tenon 611 is arranged downwards at two corners of the first [symbol] -shaped frame 62 respectively (as shown in partial enlarged view A), two horizontal ends are formed into mortise 613 or tenon 612 respectively, so as to correspond to the tenon 411 or mortise 412 at one end of the first connecting member 41. In like manner, a tenon (not shown in the figure) is arranged downwards at two corners of the second [symbol] -shaped frame 62 respectively, and two horizontal ends are formed into mortise 623 or tenon 622 respectively, so as to correspond to the tenon 411 or mortise 412 at the other end of the first connecting member 41. In like manner, the cross section of said mortise and tenon is three-circle intersection, so as to enhance the strength of elements and to avoid both of slide and influencing the stability.

The cultivating tanks 51, 52 are rectangular planters, the long sides of cultivating tanks 51, 52 correspond to the base corner mortises 311, 321 and fixed frame tenon 611, provided with connecting lugs 511, 521 for the connecting member to pass through. In like manner, the cross section of the connecting lugs is three-circle intersection, so as to enhance the strength of elements and to avoid both of the slide and influencing the stability.

One end of the connecting members 41, 42, 43, 44, 45 is formed into tenons 411, 421, 431, 441, 451, the other end is mortises 412, 422, 432, 442, 452, the members shall be joggled to extend the length.

For assembly, as shown in FIG. 4, the mortises 313, 323 or tenons 312, 322 at the horizontal end of the first [symbol] -shaped base 31 and the second [symbol] -shaped base 32 of base 3 are transversely connected to the tenon 411 or mortise 412 of the first connecting member 41 to form a rectangular frame.

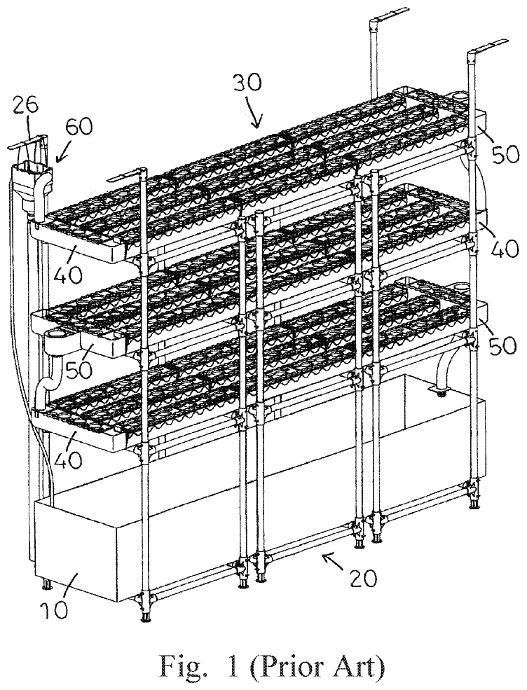

The tenon 421 of the second connecting member 42 is longitudinally inserted in the mortises 311, 321 at the corners of the first [symbol] -shaped base 31 and the second [symbol] -shaped base 32. The tenon 431 of the third connecting member 43 is inserted in the mortise 422 at the other end of the second connecting member 42, so as to extend the height longitudinally to form the first layer of support L1, the space enclosed by the first layer of support L1 is provided for placing an aquarium like that shown in FIG. 1 of the U.S. Pat. No. 9,775,330.

The first layer of cultivating tank 51 is located at the top end of the first layer of support L1, and fixed by the joint of the mortise 432 of the third connecting member 43, the connecting lug 511 of cultivating tank and the tenon 441 of the fourth connecting member 44. The space enclosed by the second layer of support L2 formed by the fourth connecting member 44 is provided for planting.

The second layer of cultivating tank 52 is located at the top end of the second layer of support L2, and fixed by the joint of the mortise 442 of the fourth connecting member 44, the connecting lug 521 of cultivating tank and the tenon 451 of the fifth connecting member 45. The space enclosed by the third layer of support L3 formed by the fifth connecting member 45 is also provided for planting.

The mortises 613, 623 or tenons 612, 622 of the first [symbol] -shaped frame 61 and the second [symbol] -shaped frame 62 of fix cover 6 are transversely connected to the tenon 411 or mortise 412 of the first connecting member 41 to form a rectangular frame.

Finally, the downward tenon 611 at the corners of the first [symbol] -shaped frame 61 and the second [symbol] -shaped frame 62 of fix cover is inserted in the mortise 452 of the fifth connecting member 45 to fix the third layer of support L3.

Through said assembly steps, the module base, cultivating tanks, fix cover and connecting members can be easy assembled by general users without specific tools. As module elements are convenient for assembly and disassembly, once an element is damaged, it can be replaced by a standard element immediately.

The frame structure disclosed in the U.S. Pat. No. 9,775,330 comprises a plurality of connectors, a plurality of upright tubes, a plurality of transverse tubes, a plurality of pins and a plurality of fasteners, the assembly is complicated. The module elements of the present invention can be easy assembled without specific tools and are convenient for replacement and maintenance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A frame structure of aquaponic system, comprising:
a base,
at least one cultivating tank,
a cover,
a first set of vertically-extending connecting members configured to extend from said base for supporting the at least one cultivating tank,
a second set of vertically-extending connecting members configured to extend from said at least one cultivating tank, or from a second said cultivating tank, for supporting the cover, and
at least a first, a second, a third, and a fourth horizontally-extending connecting member respectively included in the base and the cover,
wherein
said base is a rectangular frame composed of a first one-piece [symbol] -shaped base member, a second one-piece [symbol] -shaped base member, and said first and second horizontally-extending connecting members, which transversely connect the first [symbol] -shaped base member and the second [symbol] -shaped base member;
said cover is a rectangular frame composed of a first [symbol] -shaped frame member, a second [symbol] -shaped frame member, and said third and fourth horizontally-extending connecting members, which transversely connect the first [symbol] -shaped frame member and the second [symbol] -shaped frame member; and
said at least one cultivating tank is provided with connecting lugs for receiving respective first ends or second ends of said first set of vertically-extending connecting members;
the first end of each of said horizontally-extending and vertically-extending connecting members is formed into a tenon, and the second end of each of said horizontally-extending and vertically-extending connecting members is formed into a mortise;
the first and second [symbol] -shaped base members of the base and the first and second [symbol] -shaped frame members of the cover each includes a linear section and two arms that extend transversely with respect to the linear section to form corners, each of the arms including distal ends extending away from the corners, and each the distal ends being formed into a mortise or a tenon for connecting to one of the tenons or mortises of a respective horizontally-extending connecting member,
said first and second [symbol] -shaped base members of the base are each provided with two tenons or two mortises at respective corners, for connecting to corresponding mortises or tenons at the first or second ends of respective said first set of vertically-extending connecting members, and
said first and second [symbol] -shaped frame members of the cover are each provided with two tenons or two mortises at respective corners, for connecting to corresponding mortises or tenons at the first or second ends of respective said second set of vertically-extending connecting members.

2. The frame structure of aquaponic system in claim 1, wherein said two mortises or two tenons of each of the [symbol] -shaped base members are arranged to extend upwardly at the corners of the first [symbol] -shaped base member and the second [symbol] -shaped base member respectively for connection to said first set of vertically-extending connecting members.

3. (canceled)

4. The frame structure of aquaponic system in claim 1, wherein a respective tenon is arranged downwards at the corners of the first [symbol] -shaped frame member and the second [symbol] -shaped frame member of said cover for connection to said second set of vertically-extending connecting members.

5. (canceled)

6. The frame structure of aquaponic system in claim 2, wherein respective tenons or mortises at upper ends of the first set of vertically-extending connecting members extending from the corners of said first [symbol] -shaped base and said second [symbol] -shaped base are respectively inserted into respective mortises or tenons of a third set of vertically-extending connecting members, forming a first layer of support.

7. The frame structure of aquaponic system in claim 6, wherein the top end of said first layer of support fixes the first layer of the at least one cultivating tank by a joint including respective said mortises or tenons of third set of vertically-extending connecting members, a respective said connecting lug of the at least one cultivating tank, and respective tenons or mortises at bottom ends of a fourth set of vertically-extending connecting members, wherein said connecting lugs extend from sides of the at least one cultivating tank rather than from ends or corners of the at least one cultivating tank, and wherein a space enclosed by a second layer of support formed by the fourth set of vertically-extending connecting members is provided for plantings.

8. The frame structure of aquaponic system in claim 7, wherein a top end of said second layer of support fixes a second said at least one cultivating tank by a joint including respective mortises or tenons at top ends of the third set of vertically-extending connecting members, a respective connecting lug of the second said at least one cultivating tank, and respective tenons or mortises at bottom ends of the second set of vertically-extending connecting members, and wherein the space enclosed by a third layer of support formed by the second set of vertically-extending connecting members is provided for planting.

9. (canceled)

10. The frame structure of aquaponic system in claim 1, a cross section of each said mortise and tenon has a shape of a three-circle intersection of a Venn diagram.

11. The frame structure of aquaponic system in claim 2, a cross section of each said mortise and tenon has a shape of a three-circle intersection of a Venn diagram.

12. (canceled)

13. The frame structure of aquaponic system in claim 4, a cross section of each said mortise and tenon has a shape of a three-circle intersection of a Venn diagram.

14. (canceled)

15. The frame structure of aquaponic system in claim 6, a cross section of each said mortise and tenon has a shape of a three-circle intersection of a Venn diagram.

16. The frame structure of aquaponic system in claim 7, a cross section of each said mortise and tenon has a shape of a three-circle intersection of a Venn diagram.

17. The frame structure of aquaponic system in claim 8, a cross section of each said mortise and tenon has a shape of a three-circle intersection of a Venn diagram.

18. (canceled)
